(19) United States
(12) Patent Application Publication
(10) Pub. No.: US 2008/0258635 A1
(43) Pub. Date: Oct. 23, 2008

(54) PLASMA DISPLAY AND DRIVING APPARATUS THEREOF

(76) Inventors: Kyong-Pil Jin, Suwon-si (KR); Yoo-Jin Song, Suwon-si (KR)

Correspondence Address: CHRISTIE, PARKER & HALE, LLP, PO BOX 7068, PASADENA, CA, 91109-7068, US

(21) Appl. No.: 12/106,140

(22) Filed: Apr. 18, 2008

(30) Foreign Application Priority Data
Apr. 23, 2007 (KR) 10-2007-0039383

(51) Int. Cl. G09G 3/10

(52) U.S. Cl. 315/169.4

(57) ABSTRACT

A plasma display is provided. The plasma display includes a plasma display panel (PDP) having first electrodes, second electrodes, and third electrodes; a power supply for supplying a first voltage, a second voltage and a third voltage; a driving circuit for driving at least one of the first electrodes; and a controller for controlling the driving of the first driving circuit. The first driving circuit includes: a first photo coupler and a second photo coupler for generating signals corresponding to logic signals from the controller; a scan integrated circuit (IC) configured to selectively apply the third voltage that is lower than either the first voltage or the second voltage; a buffer for delivering the first signal and the second signal to the scan IC; and a reset circuit for driving the buffer when the first voltage is higher than a fourth voltage.

### CROSS-REFERENCE TO RELATED APPLICATION

This application claims priority to and the benefit of Korean Patent Application No. 10-2007-0039383 filed in the Korean Intellectual Property Office on Apr. 23, 2007, the entire content of which is incorporated herein by reference.

### BACKGROUND OF THE INVENTION

1. Field of the Invention

The present invention relates to a plasma display and a driving apparatus thereof.

2. Description of the Related Art

A plasma display is a flat panel display that uses plasma generated by a gas discharge to display characters or images. It includes a plasma display panel (PDP) wherein hundreds of thousands to millions of discharge cells (hereinafter referred to as cells) are arranged in a matrix format, depending on its size.

According to a typical driving method of a PDP, each frame is divided into a plurality of subfields having respective weights, and grayscales are expressed by a combination of weights from among the subfields, which are used to perform a display operation. Each subfield is divided into a reset period, an address period, and a sustain period and is then driven. A wall charge state of discharge cells are initialized in the reset period, turn-on cells are selected in the address period, and a sustain discharge operation is performed in the turn-on cells for displaying a substantial image in the sustain period.

A conventional plasma display applies a voltage that is higher than a scan voltage to scan electrodes at the end of the reset period by using the scan voltage applied to the scan electrodes for selecting turn-on cells during the address period, and a driving circuit used for this process will be described with reference to FIG. 1.

FIG. 1 shows a scan electrode driver of a conventional plasma display.

As shown in FIG. 1, a conventional driving apparatus 10 includes a first photo coupler 11, a second photo coupler 12, a buffer 13, and a scan integrated circuit (IC) 14.

The first and second photo couplers 11 and 12 respectively generate signals OC1′ and OC2′ corresponding to first and second input logic signals and transmit the generated signals to the buffer 13. The buffer 13 forwards the signals OC1′ and OC2′ to the scan IC 14. The scan IC 14 includes a selection circuit and a logic circuit. The selection circuit has two switches Sch and Scl. The logic circuit combines the signals OC1 and OC2 forwarded from the buffer 13 and selectively drives the switches Sch and Scl, and accordingly, a scan voltage or a non-scan voltage is applied to a scan electrode Y. When a Vdd voltage (e.g., 5V) is applied, the buffer 13 and the scan IC 14 are driven.

However, the scan IC 14 has a logic unit formed by a complementary metal oxide semiconductor (CMOS) that has a slow driving speed when power is applied, and therefore it is difficult to determine whether a level of signals OC1′ and OC2′ input from the buffer 13 is low or high when the Vdd voltage is initially applied and thus a level of a Vcc voltage exists within a range of 2V to 4V. That is, the scan IC 14 has an unknown state. Therefore, the scan IC 14 has a drawback in that it performs an erroneous operation, causing damage when the Vdd voltage and the VscH voltage are simultaneously applied. Particularly, such an unknown state of the scan IC 14 always occurs when an alternating current (AC) power is supplied to the conventional driving apparatus 10 or the supply of the AC power is stopped. Accordingly, a power sequence of the conventional driving apparatus 10 must be controlled. The power sequence includes start timing and stop timing of the Vdd voltage and the VscH voltage.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display that may perform a stable operation without regard to a power sequence, and a driving apparatus thereof.

In one embodiment of the present invention, a plasma display is provided. The plasma display includes a plasma display panel (PDP) having a plurality of first electrodes, a plurality of second electrodes, and a plurality of third electrodes crossing the first electrodes and the second electrodes; a power supply for supplying a first voltage, a second voltage and a third voltage by changing an input voltage; a first driving circuit for driving at least one of the first electrodes; and a controller for controlling the driving of the first driving circuit. The first driving circuit includes: a first photo coupler for generating a first signal corresponding to a first logic signal from the controller; a second photo coupler for generating a second signal corresponding to a second logic signal from a controller; a scan integrated circuit (IC) configured to be driven using the first voltage as a power voltage, and selectively apply the third voltage that is lower than either the first voltage or the second voltage, to at least one of the first electrodes in accordance with the first signal and the second signal; a buffer for delivering the first signal and the second signal to the scan IC; and a reset circuit for driving the buffer when the first voltage is higher than a fourth voltage.

In another embodiment of the present invention, a driving apparatus of a plasma display having a power supply for supplying a first voltage, a second voltage and a third voltage and having a plurality of first electrodes is provided. The driving apparatus includes: a scan integrated circuit (IC) configured to be driven using the first voltage as a power voltage, and selectively apply either the second voltage or the third voltage to at least one of the first electrodes in accordance with a first signal and a second signal, the third voltage being lower than the second voltage; a buffer for delivering the first signal and the second signal to the scan IC; and a reset circuit for driving the buffer when the first voltage is higher than a fourth voltage, wherein the reset circuit includes: a comparator for comparing a first comparison voltage with a second comparison voltage, the first comparison voltage being lower than the first voltage and having a variation slope that is substantially the same as that of the first voltage, the second comparison voltage having a variation slope that is less steep than that of the first voltage and being partially higher than the first comparison voltage at a first stage, and a first transistor being turned on/off in accordance with an output signal of the comparator, wherein the reset circuit is configured to determine whether to drive the buffer according to whether the first transistor is turned on/off.

### BRIEF DESCRIPTION OF THE DRAWINGS

FIG. 1 shows a scan driver of a conventional plasma display.

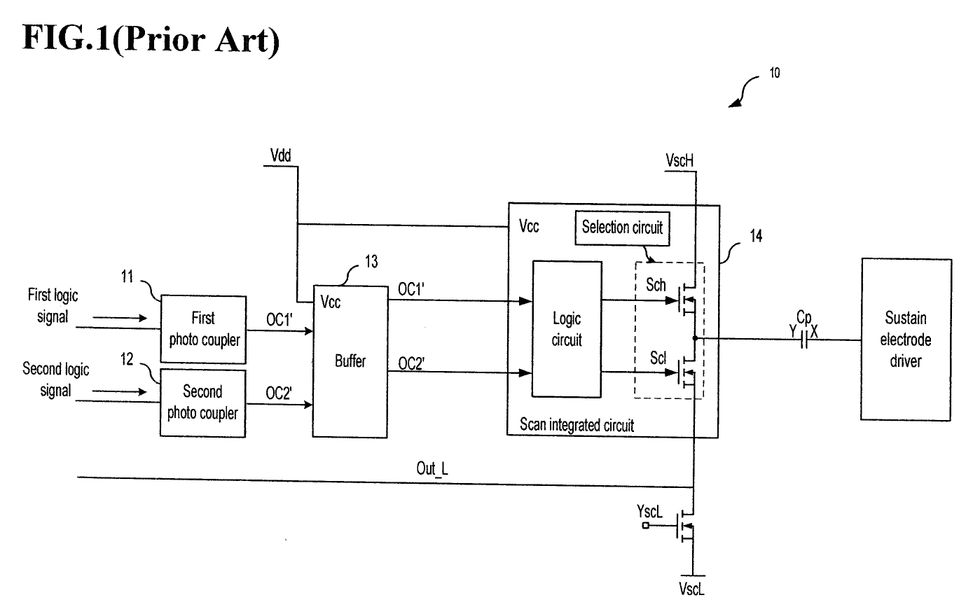

FIG. 2 is a block diagram of a plasma display according to an embodiment of the present invention.

FIG. 3 shows a scan driver included in a scan electrode driver according to the embodiment of the present invention.

FIG. 4A shows a voltage waveform of each part of a reset circuit 414 corresponding to a level of a Vdd voltage.

FIG. 4B shows an output signal of the reset circuit 414 according to the voltage waveform of FIG. 4A and a driving state of a buffer 416.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through one or more other elements. In addition, unless explicitly described to the contrary, the word “comprise” and variations such as “comprises” and “comprising” will be understood to imply the inclusion of stated elements but not the exclusion of any other elements.

A plasma display and a driving method thereof will now be described with reference to the accompanying drawings.

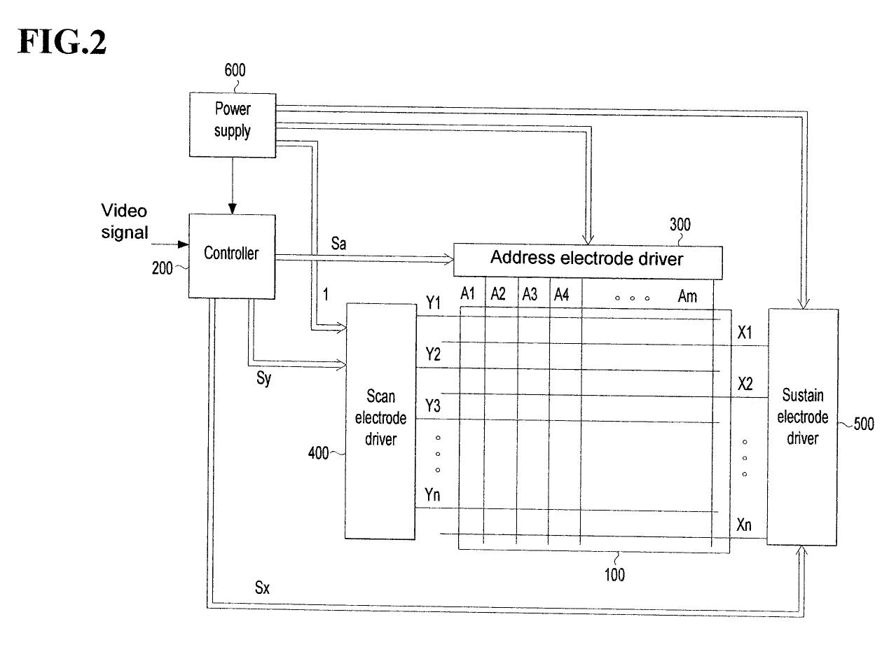

FIG. 2 is a block diagram of a plasma display according to an embodiment of the present invention.

As shown in FIG. 2, the plasma display includes a plasma display panel (PDP) 100, a controller 200, an address electrode driver 300, a scan electrode driver 400, a sustain electrode driver 500, and a power supply 600.

The PDP 100 includes a plurality of address electrodes A1 to Am extending in a column direction, and a plurality of sustain electrodes X1 to Xn and a plurality of scan electrodes Y1 to Yn extending in a row direction. Generally, the sustain electrodes X1 to Xn are formed in correspondence to the respective scan electrodes Y1 to Yn. The ends of the sustain electrodes X1 to Xn at one end are coupled to each other.

In addition, the PDP 100 includes a substrate (not shown) on which the sustain and scan electrodes X1 to Xn and Y1 to Yn are arranged, and another substrate (not shown) on which the address electrodes A1 to Am are arranged. The two substrates are placed facing each other with a discharge space therebetween so that the scan electrodes Y1 to Yn and the address electrodes A1 to Am perpendicularly cross each other and the sustain electrodes X1 to Xn and the address electrodes A1 to Am perpendicularly cross each other. Herein, the discharge spaces formed at crossing regions between the address electrodes A1 to Am and the sustain and scan electrodes X1 to Xn and Y1 to Yn form discharge cells.

The above description has been provided as an example of the structure of the PDP 100. Embodiments of the present invention can be applied to the panels having other structures.

The controller 200 receives external video signals and outputs an address electrode driving control signal Sa, a sustain electrode driving control signal Sx, and a scan electrode driving control signal Sy. In addition, the controller 200 divides one frame into a plurality of subfields and drives the subfields. Each subfield includes a reset period, an address period, and a sustain period with respect to time. Further, the controller 200 generates a scan high voltage Vscan_h applied to cells that have not been addressed during an address period by using a direct current (DC) voltage supplied from the power supply 600 and transmits the scan high voltage Vscan_h to the scan electrode driver 400 or the sustain electrode driver 500.

The address electrode driver 300 receives the address electrode driving control signal Sa from the controller 200 and applies a display data signal to each address electrode so as to select discharge cells to be displayed.

The scan electrode driver 400 receives the scan electrode driving control signal Sy from the controller 200 and applies a driving voltage to the scan electrodes Y.

The sustain electrode driver 500 receives the sustain electrode driving control signal Sx from the controller 200 and applies a driving voltage to the sustain electrodes X.

The power supply 600 supplies power for driving the plasma display device to the controller 200 and the respective drivers 300, 400, and 500.

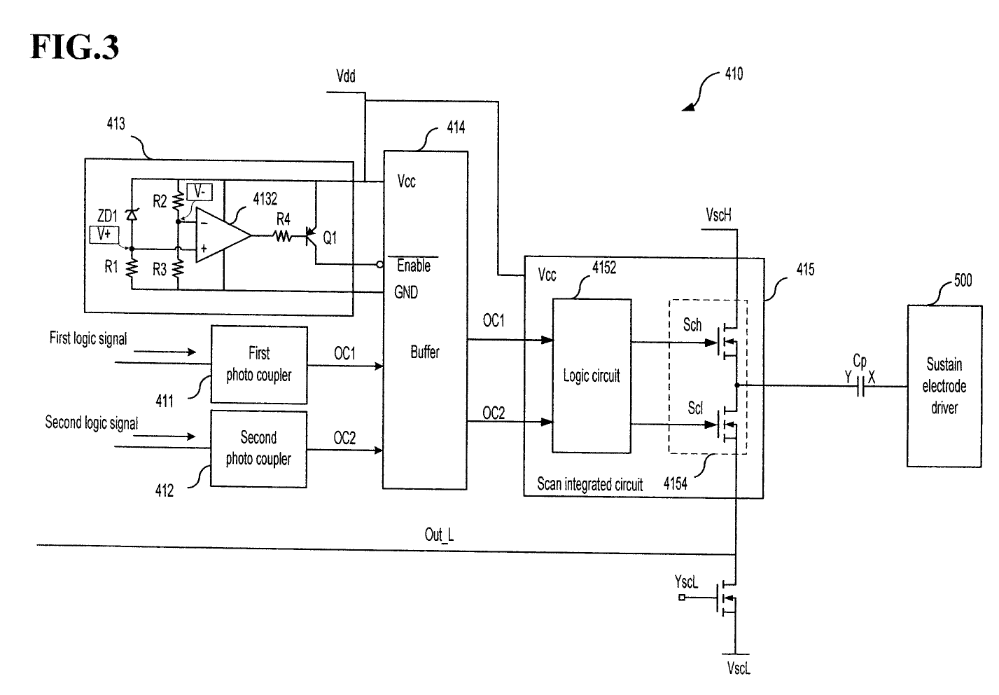

FIG. 3 shows a scan driver 410 included in a scan electrode driver 400 according to an embodiment of the present invention. While FIG. 3 illustrates only one Panel Capacitor Cp formed between one scan electrode Y and one sustain electrode X, as those skilled in the art would know, the Panel Capacitor Cp represents a plurality of Panel Capacitors formed by and between the X electrodes and the Y electrodes.

As shown in FIG. 3, the scan driver 410 includes a first photo coupler 411, a second photo coupler 412, a reset circuit 413, a buffer 414, and a scan integrated circuit (IC) 415.

The first and second photo couplers 411 and 412 respectively receive the first and second logic signals and generate corresponding signals OC1 and OC2. Here, the logic signal is a pulse signal having a high level of 3.3 V and a low level of a ground voltage, and is generated by the controller 200 of FIG. 2 and applied to the scan electrode driver 400. The signals OC1 and OC2 output from the first and second photo couplers 411 and 412 are higher than a voltage applied to an Out_L line by 5V. A sustain driver (not shown) and a reset driver (not shown) are connected to each other through the Out_L line, and the signals OC1 and OC2 respectively output from the first and second photo couplers 411 and 412 are higher than the voltage applied to the Out_L line by 5V, and therefore a voltage level of the signals OC1 and OC2 is not fixed but is changed in accordance with a voltage applied to the scan electrodes Y.

The reset circuit 413 is driven by a Vdd voltage, and controls a driving operation of the buffer 414. The reset circuit 413 includes a Zener diode ZD1, resistors R1, R2, R3 and R4, a comparator 4132, and a transistor Q1.

The Zener diode ZD1 has a cathode coupled to a power source Vdd that supplies the Vdd voltage. The resistor R1 has a first end coupled to an anode of the Zener diode ZD1 and a second end coupled to ground. A first end of the resistor R2 is coupled to the power source Vdd. The resistor R3 has a first end coupled to a second end of the resistor R2 and a second end coupled to ground. The comparator 4132 driven by the Vdd voltage has a non-inverting terminal coupled to a node between the Zener diode ZD1 and the resistor R1 and an inverting terminal coupled to a node between the resistor R2 and the resistor R3. The transistor Q1 has an emitter coupled to the power source Vdd and a collector coupled to an active low terminal Enable of the buffer 414. The resistor R4 has a first end coupled to an output end of the comparator 4132 and a second end coupled to a control electrode of the transistor Q1.

In this case, the transistor Q1 is provided as a PNP-type transistor when the comparator 4132 outputs a low-level signal. In addition, the ground end of the reset circuit 413 is coupled to the ground end of the buffer 414 so that a ground voltage of the reset circuit 413 and the buffer 414 are the same.

The buffer 414 driven by the Vdd voltage uses the Vdd voltage as a power voltage Vcc. Therefore, a power voltage of the reset circuit 413 and the buffer 414 are the same. In general, the first photo coupler 411 and the second photo coupler 412 are disposed to have a distance (e.g., a predetermined distance) therebetween on a circuit substrate, and the buffer 414 is provided to attenuate the signals OC1 and OC2 due to the distance between the first and second photo couplers 411 and 412. The buffer 414 is enabled in accordance with a level of a signal input to the active low terminal Enable from the reset circuit 413 and transmits the signals OC1 and OC2 input from the photo couplers 411 and 412 to the scan IC 415, or is disabled.

The scan IC 415 uses the Vdd voltage as the Vcc voltage and is operative when the Vdd voltage is supplied. The scan IC 415 includes a logic circuit 4152 and a selection circuit 4154. The logic circuit 4152 combines the signals OC1 and OC2 input from the buffer 414 and selectively drives two transistors Sch and Scl included in the selection circuit 4154. Therefore, the logic circuit 4152 includes a truth table according to the input signals OC1 and OC2, and generates an output signal corresponding to a level of the respective input signals OC1 and OC2. For example, the logic circuit 4152 turns off the transistors Sch and Scl in a high impedance state when both the input signals OC1 and OC2 have a low level.

The selection circuit 4154 includes the transistor Sch having a drain coupled to a power source VscH that supplies a VscH voltage, and the transistor Scl having a drain coupled to a source of the transistor Sch and a source coupled to a drain of a transistor YscL. In this case, the transistors Sch and Scl are turned on/off corresponding to the signals OC1 and OC2 input from the buffer 414, and selectively apply a scan voltage VscH or a non-scan voltage VscL to the scan electrode Y. A turn-on timing of the transistor YscL for applying the non-scan voltage VscL to the scan electrode Y is controlled by the controller 200 of FIG. 2 so as to be matched to a turn-on timing of the transistor Scl.

FIG. 3 illustrates one selection circuit 4154 and one scan electrode Y corresponding to the selection circuit 4154, but integrated circuit-type selection circuits 4154 are provided corresponding to a plurality of scan electrodes Y1 to Yn so as to sequentially select the plurality of scan electrodes Y1 to Yn during an address period. The scan driver 410 is commonly coupled to the scan electrodes Y1 to Yn through the selection circuit 4154.

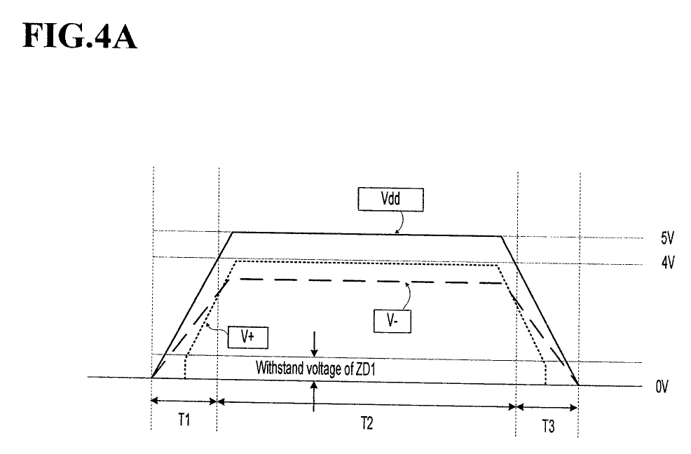

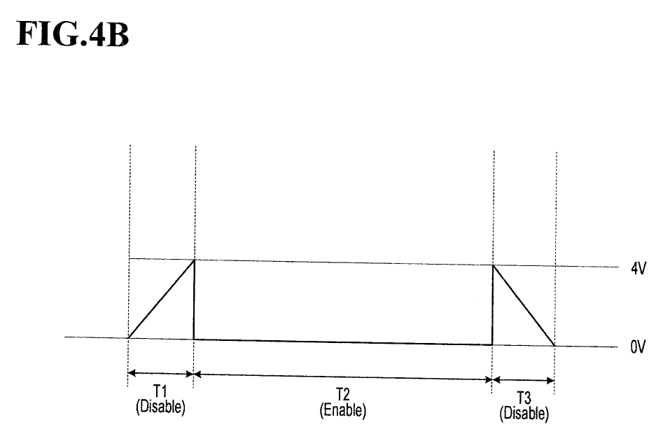

Driving operations of the reset circuit 413 and the scan IC 415 included in the scan driver 410 corresponding to a level of the Vdd voltage according to the embodiment of the present invention will be described with reference to FIGS. 4A and 4B.

FIG. 4A shows a driving waveform of each part in the reset circuit 413 corresponding to a level of the Vdd voltage according to the embodiment of the present invention, and FIG. 4B shows an output signal of the reset circuit 413 and a corresponding driving state of the buffer 414.

During a period T1, the Vdd voltage is applied to the scan driver 410 of FIG. 3 from the power supply 600 of FIG. 2 and thus the Vdd voltage is increased from 0V with a slope (e.g., a predetermined slope). A voltage V− input to the inverting input terminal of the comparator 4132 is a voltage divided from the Vdd voltage by the resistor R2 and the resistor R3, and increases with a slope that is less steep than the slope of the Vdd voltage. A voltage V+ input to the non-inverting input terminal of the comparator 4132 is a voltage that is lower than the Vdd voltage by a withstand voltage of the Zener diode ZD1, and increases as the Vdd voltage increases. In this case, an increase slope of a variation curve of the voltage V+ input to the non-inverting input terminal of the comparator 4132 corresponds to an increase slope of a variation curve of the Vdd voltage.

Accordingly, the slope of the variation curve of the voltage V+ input to the non-inverting input terminal of the comparator 4132 is steeper than that of the variation curve of the voltage V− input to the inverting terminal of the comparator 4132. As a result, the variation curve of the voltage V+ input to the non-inverting input terminal of the comparator 4132 crosses the variation curve of the voltage V− input to the inverting input terminal of the comparator 4132. In one embodiment, resistance values of the resistors R2 and R3 and the withstand voltage of the Zener diode ZD1 are set to make the variation curve of the V− voltage and the variation curve of the voltage V+ cross each other at a point when the Vdd voltage is increased to 4V.

During the period T1, the voltage V− input to the inverting input terminal of the comparator 4132 is maintained higher than the voltage V+ input to the non-inverting terminal of the 4132. As a result, an output signal of the comparator becomes a low level and the transistor Q1 is turned on so that an output signal of the reset circuit 413 increases along an increase slope of the Vdd voltage. Herein, since the buffer 414 receives the output signal of the reset circuit 413 through the active low terminal Enable, the buffer 416 is in a disable state and therefore the scan IC 415 outputs low-level signals. Accordingly, the scan IC 415 does not operate during the period T1. During a period T2, the Vdd voltage is increased to 5V and maintained at 5V for a time period (e.g., a predetermined time period), and then decreased. The variation curve of the voltage V+ input to the non-inverting input terminal of the comparator 4132 becomes higher than that of the voltage V− input to the inverting input terminal of the comparator 4132, and then the variation curve of the voltage V+ decreases as the Vdd voltage decreases and crosses the variation curve of the voltage V−. In this case, a crossing point corresponds to a level of 4V as in the period T1.

During the period T2, the voltage V+ input to the non-inverting input terminal of the comparator 4132 becomes higher than the voltage V− input to the inverting input terminal of the comparator 4142. Accordingly, the comparator 4132 outputs a high-level signal and the transistor Q1 is turned off so that the reset circuit 413 outputs a low-level signal. In this case, the buffer 414 is operated in an enable state since it has received the output signal of the reset circuit 413 through the active low terminal Enable, and normally operates the scan IC 415 by delivering the signals OC1′ and OC2′ input from the first and second photo couplers 411 and 412 to the scan IC 415.

During a period T3, the Vdd voltage is decreased to 0V with a slope (e.g., a predetermined slope). Accordingly, the variation curve of the voltage V+ input to the non-inverting input terminal of the comparator 4132 is decreased with the same slope as the variation curve of the Vdd voltage until the voltage V+ is decreased to the withstand voltage of the Zener diode ZD1 and then the voltage V+ is suddenly dropped to 0V, and the voltage V− input to the inverting input terminal of the comparator 4132 is decreased to 0V with a slope that is lower than that of the variation curve of the Vdd voltage.

As in the period T1, the voltage V− input to the inverting terminal of the comparator 4132 is maintained higher than the voltage V+ input to the non-inverting terminal of the comparator 4132 during the period T3. Accordingly, the comparator 4132 outputs a low-level signal and the transistor Q1 is turned on so that an output signal of the reset circuit 413 decreases as the Vdd decreases. In this case, the buffer 414 receives the output signal of the reset circuit 413 through the active low terminal Enable and therefore the buffer 414 is in the disable state and the scan IC 415 outputs low-level signals OC1′ and OC2′. As a result, the scan IC 415 is not driven during the period T3.

As described, the scan IC 415 is set to be not driven during the periods T1 and T3 so as to prevent operation errors or damage to the scan IC 415 due to an unknown state generated when a power voltage applied to the scan IC 415 is included within a range of 2V to 4V. Accordingly, the Vdd voltage and the VscH voltage can be simultaneously (or concurrently) applied since the scan driver 410 does not need to separately control a power sequence (i.e., supply start timing and supply stop timing) of the Vdd voltage and the VscH voltage.

When simultaneously (or concurrently) applying the Vdd voltage and the VscH voltage to the scan driver 410 according to the embodiment of the present invention, a logic signal is input to the scan driver 410 after the Vdd voltage and the VscH voltage are started to be applied to the scan driver 410 when a power on sequence of the scan driver 410 is performed. When the power off sequence of the scan driver 410 is performed, the application of the Vdd voltage and the VscH voltage to the scan driver 410 is stopped after stopping the input of the logic signal to the scan driver 410. Herein, a time difference occurs between supply timing and stop timing of the Vdd voltage and the VscH voltage to the scan driver 410 and input timing and stop timing of the stop timing of the logic signal to the scan driver 410.

An operation error may occur in the first and second photo couplers 411 and 412 and thus they may transmit an output signal to the buffer 414 even though no signal is input to the first and second photo couplers 411 and 412. In this case, an operation error of the scan IC 415 can be prevented by using the scan driver 410 according to the embodiment of the present invention.

According to another embodiment of the present invention, the Vdd voltage may have a voltage level other than 5V, and accordingly, an unknown state may exist within a range other than the range of 2V to 4V. In this case, the variation curve of the voltage V− input to the inverting input terminal of the comparator 4132 and the variation curve of the voltage V+ input to the non-inverting input terminal of the comparator 4132 may be set to cross each other at a point when the Vdd voltage is increased over a predetermined voltage level where the unknown state exists by controlling the resistance values of the resistors R2 and R3 and the withstand voltage of the Zener diode ZD1 included in the reset circuit 413 of the scan driver 410.

In addition, the scan driver 410 included in the scan electrode driver 400 may be used as a scan driver included in the sustain electrode driver 500 for driving the sustain electrode X. One difference between the scan driver 410 and the scan driver included in the sustain electrode driver 500 may be the selection circuit 4154. Since the sustain electrodes X are typically coupled together, the scan driver in the sustain electrode driver 500 does not necessarily include the selection circuit 4154.

According to the above-described embodiments of the present invention, the occurrence of the unknown state of the scan IC within the range of 2V to 4V, causing the operation error or damage of the scan IC, may be prevented.

In addition, since there is no need for separately controlling the power sequence (i.e., supply timing and stop timing of power voltage), the driving circuit can be simplified.

In addition, a normal operation of the scan IC may be guaranteed even though the photo coupler performs an erroneous operation, thereby improving reliability of the plasma display.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A plasma display comprising:
a plasma display panel (PDP) having a plurality of first electrodes, a plurality of second electrodes, and a plurality of third electrodes crossing the first electrodes and the second electrodes;
a power supply for supplying a first voltage, a second voltage and a third voltage;
a first driving circuit for driving at least one of the first electrodes; and
a controller for controlling the driving of the first driving circuit, the first driving circuit comprising:
a first photo coupler for generating a first signal corresponding to a first logic signal from the controller;
a second photo coupler for generating a second signal corresponding to a second logic signal from the controller;
a scan integrated circuit (IC) configured to be driven using the first voltage as a power voltage, and to selectively apply the third voltage that is lower than either the first voltage or the second voltage, to at least one of the first electrodes in accordance with the first signal and the second signal;
a buffer for delivering the first signal and the second signal to the scan IC; and
a reset circuit for driving the buffer when the first voltage is higher than a fourth voltage.

2. The plasma display of claim 1, wherein the reset circuit is configured to compare a first comparison voltage with a second comparison voltage and determine whether to drive the buffer according to a comparison result, the first comparison voltage being lower than the first voltage and having a variation slope that is substantially equal to a variation slope of the first voltage, and the second comparison voltage having a variation slope that is less steep than that of the first voltage and being higher than the first comparison voltage in a first stage.

3. The plasma display of claim 2, wherein the reset circuit is configured to drive the buffer when the first comparison voltage is higher than the second comparison voltage.

4. The plasma display of claim 2, wherein the reset circuit comprises:
a Zener diode having a cathode coupled to a first power source that is configured to supply the first voltage;
a first resistor having a first end coupled to the Zener diode and a second end coupled to ground;
a second resistor having a first end coupled to the first power source;
a third resistor having a first end coupled to a second end of the second resistor and a second end coupled to the ground;
a comparator having a first input terminal coupled to a first node between the Zener diode and the first resistor and a second input terminal coupled to a second node between the second resistor and the third resistor; and
a transistor having a first end coupled to the first power source and a control electrode coupled to an output end of the comparator.

5. The plasma display of claim 4, wherein the first comparison voltage corresponds to a voltage at the first node and the second comparison voltage corresponds to a voltage at the second node.

6. The plasma display of claim 4, wherein the comparator is configured to output a first level signal when the voltage at the first node is higher than the voltage at the second node, and to output a second level signal when the voltage at the first node is lower than the voltage at the second node.

7. The plasma display of claim 6, wherein the transistor is configured to be turned off when the comparator outputs the first level signal, and to be turned on when the comparator outputs the second level signal.

8. The plasma display of claim 7, wherein the buffer comprises a first terminal coupled to a second end of the first transistor and is configured to receive a driving control signal output from the reset circuit.

9. The plasma display of claim 8, wherein the buffer is configured to be driven when the first transistor is turned off and to be not driven when the first transistor is turned on.

10. The plasma display of claim 7, wherein the first level signal is a high level signal and the second level signal is a low level signal.

11. The plasma display of claim 1, wherein the scan IC comprises:
a logic circuit for combining the first signal and the second signal and generating a third signal and a fourth signal; and
a selection circuit for applying either the second voltage or the third voltage to at least one of the first electrodes in accordance with the third signal and the fourth signal.

12. The plasma display of claim 11, wherein the selection circuit comprises:
a second transistor having a first end coupled to a second power source that is configured to supply the second voltage and a second end coupled to the at least one of the first electrodes; and
a third transistor having a first end coupled to at least one of the first electrodes and a second end coupled to a first end of a fourth transistor, wherein a first control electrode and a second control electrode of the second transistor and the third transistor are, respectively, coupled to an output end of the third signal and an output end of the fourth signal of the logic circuit.

13. The plasma display of claim 12, wherein the fourth transistor has a second end coupled to a third power source that supplies the third voltage, and is configured to be driven in accordance with control of the controller.

14. The plasma display of claim 13, wherein the third voltage is a scan voltage that is sequentially applied to the plurality of first electrodes during an address period.

15. A driving apparatus of a plasma display having a power supply for supplying a first voltage, a second voltage and a third voltage and a plurality of first electrodes, the driving apparatus comprising:
a scan integrated circuit (IC) configured to be driven using the first voltage as a power voltage, and to selectively apply either the second voltage or the third voltage to at least one of the first electrodes in accordance with a first signal and a second signal, the third voltage being lower than the second voltage;
a buffer for delivering the first signal and the second signal to the scan IC; and
a reset circuit for driving the buffer when the first voltage is higher than a fourth voltage,
wherein the reset circuit comprises:
a comparator for comparing a first comparison voltage with a second comparison voltage, the first comparison voltage being lower than the first voltage and having a variation slope that is substantially the same as that of the first voltage, the second comparison voltage having a variation slope that is less steep than that of the first voltage and being higher than the first comparison voltage at a first stage, and
a first transistor being turned on/off in accordance with an output signal of the comparator, wherein the reset circuit is configured to determine whether to drive the buffer according to whether the first transistor is turned on/off.

16. The driving apparatus of claim 15, wherein the first comparison voltage is higher than or equal to the second comparison voltage when the first voltage is higher than the fourth voltage.

17. The driving apparatus of claim 16, wherein the comparator turns off the first transistor when the first comparison voltage is less than the second comparison voltage, and turns on the first transistor when the first comparison voltage is higher than the second comparison voltage.

18. The driving apparatus of claim 16, wherein the buffer is configured to be driven when the first transistor is turned off and to be not driven when the first transistor is turned on.

19. The driving apparatus of claim 15, wherein the third voltage is a scan voltage that is sequentially applied to the plurality of first electrodes during an address period.
